(19) United States
(12) Patent Application Publication
(10) Pub. No.: US 2003/0082351 A1
(43) Pub. Date: May 1, 2003

(54) Receiver media for high quality ink jet printing

(75) Inventor: Constantine N. Anagnostopoulos, Mendon, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/039,441

(22) Filed: Oct. 29, 2001

(51) Int. Cl. B41M 5/00; B41J 2/01

(52) U.S. Cl. 428/195; 347/105

(57) ABSTRACT

Disclosed is a media, and an imaging process employing the media, for receiving jetted ink containing imaging dye, comprising a support bearing a predetermined array of three dimensional cells composed of cell walls and having a hydrophilic base, the cross section of the cells parallel to the support being of a size sufficiently small so as to improve the range of color gradations attainable.

### CROSS-REFERENCE TO RELATED APPLICATIONS

This application is hereby cross-referenced to commonly assigned co-filed applications Serial No.______, (Attorney Docket No. 83230) which is directed to fusible hydrophobic cells and Serial No.______, (Attorney Docket No. 83231) which is directed to a method of forming a cellular ink-jet media.

### FIELD OF THE INVENTION

This invention relates to a media for receiving jetted ink containing imaging colorant comprising a support bearing a predetermined array of three dimensional cells on a support, the cross section of the cells parallel to the support being of a size sufficiently small so as to improve color image quality.

### BACKGROUND OF THE INVENTION

Prints made using an inkjet printer desirably have image resolution of about 6 line pairs/mm, which corresponds to about 84 μm per line or equivalently about 300 dots per inch. They must have a dynamic range of about 128 gray levels or more in order to be comparable in image quality to conventional photographic prints.

Secondary colors are formed as combinations of primary colors. The subtractive primary colors are cyan, magenta and yellow and the secondary ones are red, green and blue. Gray can be produced by equal amounts of cyan magenta and yellow, but less fluid is deposited on the paper if the gray is produced from an ink supply containing only black dye or pigment.

Typically, a high resolution commercial print head emits 4 pL droplets. A 4 pL droplet has a diameter of about 20 μm in the air and forms a disk of about 30 μm on the paper. Adjacent droplets are typically aimed to be placed on 21 μm centers so that adjacent disks on the paper have some overlap and thus ensure that full area coverage is obtained and that a small misdirection of a jet does not produce visible artifacts. If, as taught in U.S. Pat. No. 6,089,692 of Anagnostopoulos, a saturated spot of a secondary color is to be formed, at least 256 droplets (128 of each of the primary colors) have to be deposited per 84×84 μm² area. The amount of fluid deposited per unit area is then about 145 mL/m².

This fluid level is at least a factor of 6 higher than the fluid holding capacity of commercial photo-grade inkjet papers. See for example Kenzo Kasahara, “A New Quick-Drying, High Water Resistant Glossy Ink Jet paper,” Proceedings IS&T's NIP 14:1998 International Conference on Digital printing Technologies, Toronto, Canada, Oct. 18-23, 1998, pp 150-152.

One way of solving this first problem is to increase the fluid capacity of the ink-jet paper by increasing the thickness of its ink-receiving layer. This is typically not advisable because color saturation and image resolution are reduced since the dyes diffuse too far below the surface.

Another way of increasing the apparent fluid holding capacity is to allow some evaporation to take place before depositing additional droplets. This increases the printing time and is thus also not acceptable.

A third solution is to have inks available at the print head of different dye concentrations. Thus, the high color density areas are printed with dots that have high concentration of dye while the light color areas on the print are made with low dye concentration droplets. This approach substantially increases the cost to the consumer and is thus also not an acceptable solution. Furthermore, the image quality is not photographic when a limited choice of ink dye densities are available at the print head.

A second problem with regards to producing photographic quality ink-jet prints, using currently commercially available inkjet printers, is that the penetration rate of ink into the ink-receiving layer of porous or swellable commercial receivers is too slow. This is because the porous media are purposely made to have small surface pores in order to have a glossy finish and the swellable media absorb the fluid by a diffusion process, which is also slow. Consequently the printing algorithms are written such that they do not allow a droplet to be placed on top or adjacent to another droplet until sufficient time has elapsed. This results in slow printing time and is therefore unacceptable. If an attempt is made to print faster, coalescence and color bleed are observed. That is, the small pores or slow diffusion prevent the first ink droplet from being absorbed into the paper quickly enough and, if the next droplet arrives too soon, the two merge or coalesce into one large one. This reduces the image resolution. Color bleed is essentially the same effect as coalescence, except that the two droplets that merge contain different colorants. The effect is poor image sharpness and color quality.

There are a large number of commercial ink-jet papers. Two of the most successful are described briefly here. The first is shown in FIG. 1. The receiver, as described in U.S. Pat. No. 6,045,917 of Missell et al., consists of a plain paper base covered by a polyethylene coat. This coat prevents any fluid, especially water from the ink, from penetrating into the paper base and causing puckering or wrinkling termed “cockle”. The front side of the paper is additionally coated with two layers of polymers containing mordant. The polymer layers absorb the ink by swelling while the dyes are immobilized in the mordant. An anti-curl layer is also coated in the backsides of this paper.

The second commercial paper is described by Kenzo Kasahara, in “A New Quick-Drying, High-Water Resistant Glossy Ink Jet paper,” Proceedings IS&T's NIP 14:1998 International Conference on Digital printing Technologies, Toronto, Canada, Oct. 18-23, 1998, pp 150-152, and is shown in FIG. 2. Like the first paper, the paper base is coated with a polyethylene film to prevent cockle. The ink-receiving layer consists of three separate layers. Each one is made up of ICOS (inorganic core/organic shell) particles in a polyvinyl alcohol binder and boric acid hardener, forming a micro-porous structure. The porosity of all three layers combined is about 25ml/m². Each of the ICOS particles, which are of the order of 0.05 μm in diameter, consists of an anionic silica core surrounded by a cationic polymer shell.

Other recent articles describe inkjet papers with surface pores or micro-capillaries formed by alumina or silica particles (see for example Aidan Lavery, “Photomedia for Ink Jet printing,” Proceedings IS&Ts NIP16:2000, International Conference on Digital Printing Technologies, Vancouver Canada, Oct. 16-20, 2000, pp 216-220) or micels (see for example Dieter Reichel and Willy Heinzelmann, “Anisotropic porous Substrates for High Resolution Digital Images,” Proceeding IS&Ts NIP16:2000 International Conference on Digital Printing Technologies, Vancouver Canada, Oct. 16-20, 2000, pp 204-207). In all these cases the goal is to rapidly move the fluid, through capillary action, below the surface so as to reduce coalescence and color bleed, which occurs mostly at the surface. None of these, however, move the fluid fast enough to meet the productivity needs required for photographic quality prints.

Inkjet print heads have been recently invented that are page wide and have nozzle spacing of 300 to 1200 per inch or even finer. See, for example, U.S. Pat. No. 6,079,821, of Chwalek et al. Such print heads can produce smaller 1 to 2 pL droplets than current commercial print heads. Also, because they are page wide and have a large number of nozzles, they are capable of ink lay down rates substantially higher than that of the scanning type conventional ink-jet printers. But coalescence and color bleed at the receiver surface compromise their productivity. This constitutes the third problem, namely that the present receiver media seriously limit the productivity of these advanced print heads.

Finally, for high resolution and improved color saturation, the colorants should reside within only a few microns from the surface of the receiver, which requires that the ink-receiving layers be thinner rather than thicker.

A need therefore exists for a type of image receiver media that is capable of accepting fluid lay down quantities that exceed the amount their inkreceiving layers can hold and that more readily allow a droplet to be placed simultaneously on top or adjacent to a previous one without coalescence or color bleed between adjacent droplets.

### SUMMARY OF THE INVENTION

The invention provides a media for receiving jetted ink containing imaging colorant, comprising a support bearing a predetermined array of three dimensional cells composed of cell walls and a base, the cross-section of the cells parallel to the support being of a size sufficiently small so as to improve the color image quality attainable compared to cells of larger size. The invention also includes an imaging process employing the media.

to improve the range of color gradations attainable.

Embodiments of the invention provide reduced coalescence and color bleed of the jetted ink. Embodiments also enable the media to accept fluid lay down quantities that exceed the amount the image receiving layer can otherwise hold and allow a droplet to be placed simultaneously on top of or adjacent to a previous one without coalescence or color bleed between adjacent droplets.

### BRIEF DESCRIPTION OF THE DRAWINGS

FIGS. 1 and 2 are schematic examples showing cross sectional views of two conventional ink-jet media of the prior art.

FIGS. 3a/3b and 4a/4b are plan and cross sectional views of two different embodiments of portions of ink-jet media of the invention.

FIGS. 5 and 6 are cross sectional views of the embodiments of FIGS. 3 and 4 after fusing of the cell wall structure.

FIG. 7 is a schematic showing the 5×5 sub-pixel make up of an 84×84 μm pixel.

FIG. 8 is a schematic plan view of one cell arrangement useful in the invention.

FIG. 9 is a schematic cross sectional view showing the separation of droplets.

FIG. 10 is a schematic plan view of a second cell arrangement useful in the invention.

### DETAILED DESCRIPTION OF THE INVENTION

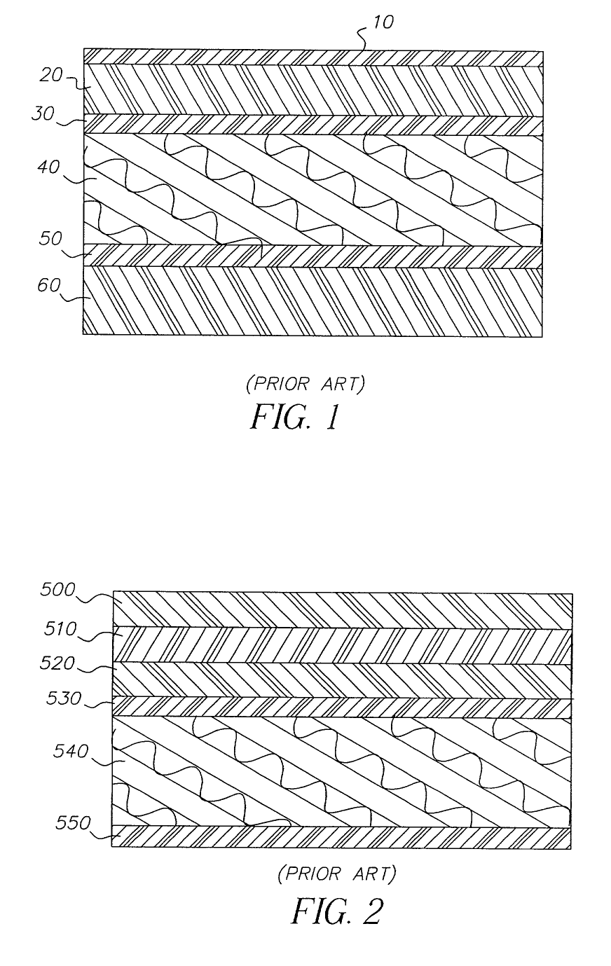

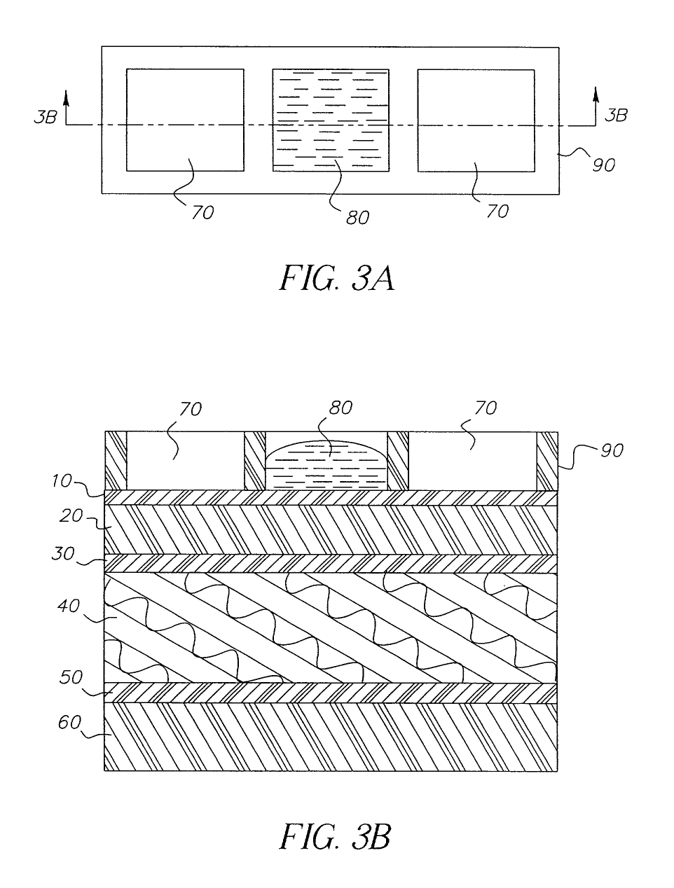

The media of the present invention is different from conventional media in that it does not depend on ink diffusion or absorption by capillary action to avoid coalescence and color bleed. Instead the surface of the receiver is covered with a predetermined array of regular shaped reservoirs or cells that hold the fluid and keep it from communicating with adjacent drops. Such a cell array is shown in FIG. 3 and is formed on top of the conventional ink-jet paper shown in FIG. 1. FIG. 1 shows a prior art ink-jet media comprising a paper base or support 40 separated from backside anti-curl layer 60 by polyethylene resin film 50. The paper base is coated with polyethylene film 30, bottom swellable polymer containing mordant 20 and top swellable polymer containing mordant 10. The polyethylene film 30 prevents the ink carrier fluid from entering the paper.

FIG. 2 shows a similar prior art media to FIG. 1, comprised of polyethylene layers 550 and 530 sandwiched about paper base 540 and bearing ink-receiving layers 500, 510, and 520.

FIGS. 3a and 3b show the inventive embodiment derived from FIG. 1 in which the cell walls 90 of the cells 70, are supported on the swellable polymer 10. Recently deposited ink droplet 80 is contained in the cell.

An alternative architecture is shown in FIGS. 4a and 4b where the cell array is built on top of the polyethylene coat, and then the image-receiving or dye holding layer is deposited on the base of each cell. These figures show the inventive embodiment derived from FIG. 1 in which the cell walls 90 of the cells 70 are bonded to the polyethylene layer 30 and the swellable polymers 10 and 20 are located on the cell bottoms.

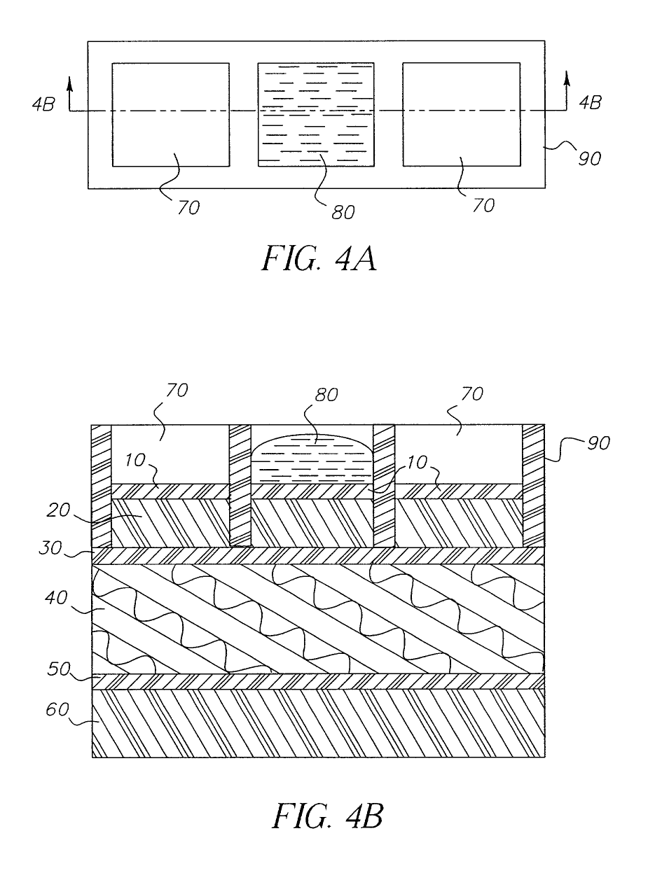

FIG. 5 shows the schematic cross section of FIG. 3 after fusing in which the cell walls have been converted to a smooth over-layer 100 and ink droplet 80 has spread out during absorption. FIG. 6 shows the schematic cross section of FIG. 4 after fusing in which the cell walls have been converted to smooth over-layer 100.

In operation, the cells receive the ink from the print head and by the end of the printing cycle much of the ink still remains confined in the cells. The receiver is then moved to a holding area and kept there until the volatile portion of the ink evaporates or a portion of the volatile components as well as the non-volatile components diffuse into the ink receiving layers below. Because of the cell structure, the paper sheets can be stacked one on top of each other since the cell walls can serve as standoffs. If the cells are left standing, they will produce a structured or matte surface appearance because of the light scattering off the cell walls. If a glossy finish is desired, then the media may, after application of the ink, be subjected to elevated temperature and or pressure e.g. via a heated roller that melts or fuses the walls of the cells. This process gives the image a glossy finish and forms a continuous overcoat film, shown schematically in FIGS. 5 and 6, similar to what lamination accomplishes. As a further advantage, this protects the image from water and abrasion damage and can offer UV and/or other protection for long dye stability and image life. In FIG. 6, the portions of the cell walls adjacent to the image- receiving layer are shown broken. This occurs during melting to allow dye diffusion sideways for better image quality. Also, the sub-pixels shown in FIG. 6 may have shapes other than squares, such as rhombus, hexagonal, or diamond shaped, and appropriate wall orientation for easier wall collapse under the application of heat and pressure.

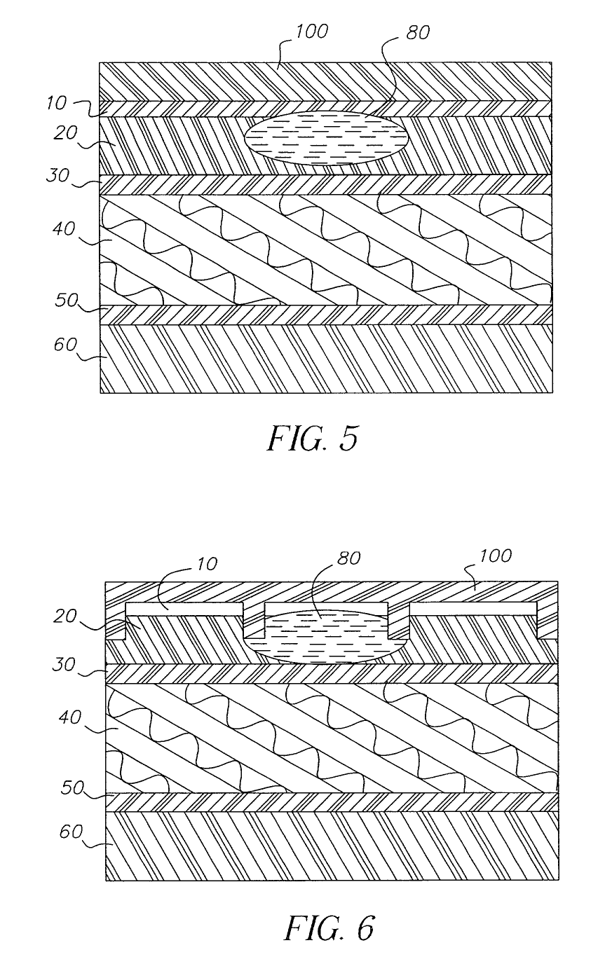

The desired cell array, area, and volume depend on the desired final image quality. Consider a printer using full density primary color inks and depositing 1 pL droplets. The droplets are about 12 μm diameter spheres when in the air and produce an image of a circular disc on conventional ink jet papers of a diameter about 50% larger than their diameter in air. The spread or dot gain increase depends on the drop velocity, how hydrophilic the surface is, and the rate of absorption of the fluid into the paper. For a secondary color, as discussed previously, two droplets are needed per site. The smallest spot size visible by the human eye is about 84×84 μm². Since a 1 pL droplet produces an image on the paper of about 18 μm in diameter, then the pixel can now be subdivided (though no actual boundaries exist, of course, in conventional inkjet papers) into an array of 5×5 subpixel ink absorbing areas 600, each about 17 μm in diameter, as shown in FIG. 7.

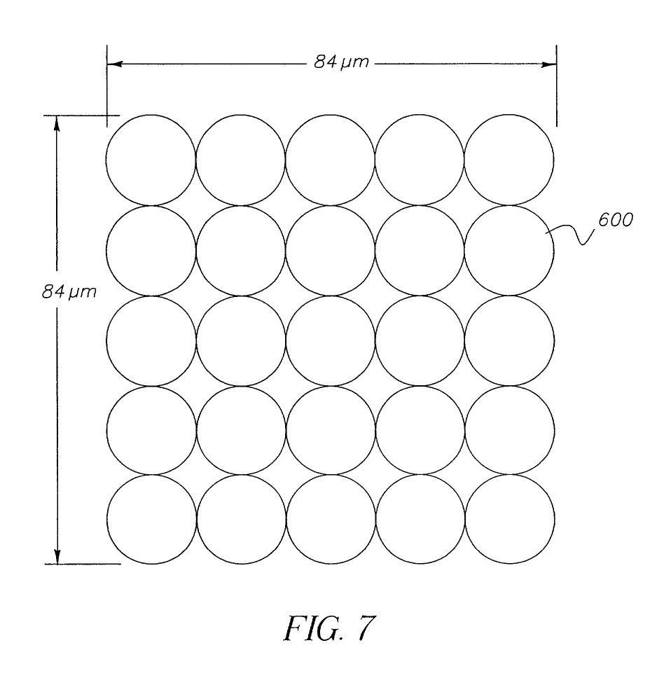

Without any subpixel cell boundaries, as is the case for conventional inkjet papers, substantial overlap of adjacent droplets is possible which can lead to drop coalescence and color bleed. One way of preventing coalescence and color bleed is to create a ring pattern on the surface of the conventional ink jet paper consisting of a transparent essentially hydrophobic film, as shown in FIG. 8. FIG. 8 shows an array as in FIG. 7 comprised of the rings 610 and the sub-pixel ink holding area 600. Other patterns besides circles for the sub-pixels may also be suitable.

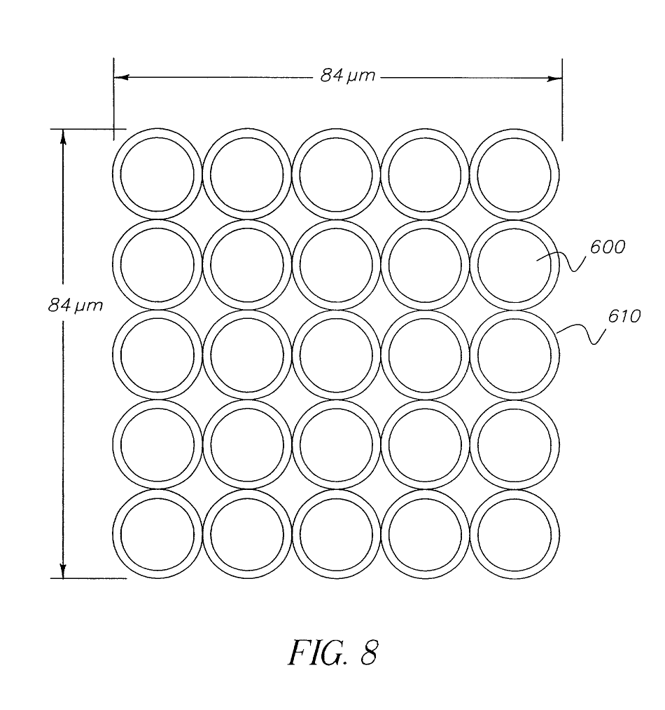

A schematic cross sectional view of two adjacent sub-pixels containing fluid is shown in FIG. 9. FIG. 9 shows how rings separate the different density and or different colored ink drops 82 and 84 from each other. The film, which constitutes the rings, prevents the spreading of the fluid on the surface and thus contains the droplets within their corresponding sub-pixel, thus preventing coalescence. The line widths of the rings may vary from 1 to 10 μm and their height can vary from <<1 μm to >1 μm. However, since no ink stays on top of the top of the cell wall areas, for full dye area coverage, the ink will desirably diffuse under them from the adjacent ink receiving regions. In the instances where the cell wall material is very thin, there is no need to subject the print to a high temperature and pressure step after printing.

One disadvantage of using full dye density inks is that in the low density areas of an image, where droplets are placed far apart, the image looks grainy or noisy in those locations. This is the reason many commercial ink jet printers have two extra ink supplies one of low dye density cyan color and one low dye density magenta color, though this is still not sufficient for high “photographic quality” prints.

To obtain the higher image quality, the sub-pixels must be able to contain more than one or two droplets of ink. This is accomplished by increasing the heights of the sub-pixel walls thus increasing their volume or ink holding capacity. Note that, as disclosed in U.S. Pat. No. 6,089,692 of Anagnostopoulos, the dye concentration in the ink must now be ⅛ the saturation value. That is, it takes 8 droplets one on top of another of one primary color to achieve a fully saturated spot of that color on the paper. For a secondary color 16 droplets are required, 8 of each primary color. The advantages of the diluted ink are higher dynamic range within a single pixel and, in the low-density areas of a print, less grain or noise without the need for extra supplies of low dye density inks. Excess dynamic range can be used for banding and other artifact correction or other image quality enhancements.

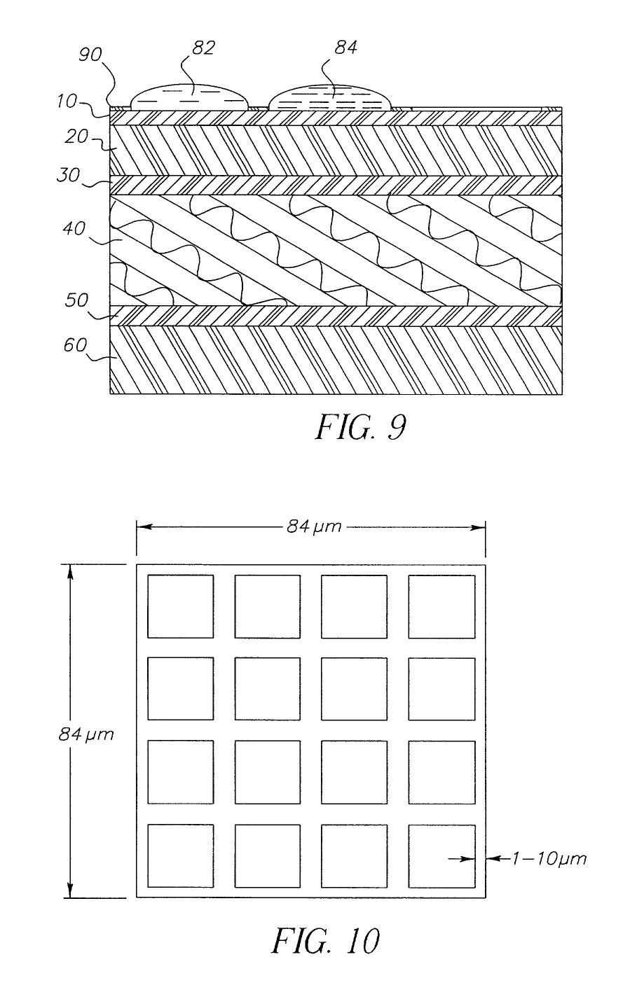

Rather than having circular cells, on the surface of the inkjet paper, we may have any other suitable shape such as rectangular ones, as shown in FIG. 10, or hexagonal ones, because they can hold more fluid and fill the space more efficiently. FIG. 10 is another schematic plan view of an array of cells 100 bordered by the walls 90 in which the cells are rectangular or square in shape.

In FIG. 10, the subpixel size is drawn 21×21 μm². Assuming that the print head produces 1 pL droplets and that the walls of the cells are 2 μm wide, then for a fully saturated primary color spot the wall heights have to be about 28 μm to accommodate 8 pL of fluid or about 8,000 μm³ of fluid volume per subpixel. For a fully saturated secondary color spot the wall heights will have to be about 56 μm. This will give a maximum of 129 levels of color density gradations per pixel, that is, 16 sub-pixels×8 color density gradations or gray levels per sub-pixel equals 128. The null, that is, no ink in any subpixels, adds another level. As droplets are deposited within each sub-pixel, evaporation and diffusion of the ink is taking place, thus these wall heights represent the worst case maximum. By way of comparison, in the case discussed above with reference to FIG. 7, the cell walls had no substantial height, the maximum number of color gradations per pixel is 26.

Embodiments of the invention exhibit improved color gradation, enhanced image quality, and increased printing productivity. These features flow from the ability to reduce the amount of color mixing and the ability to reduce the degree of smearing of the ink prior to drying to the presence of the cells.

To avoid possible Moire pattern formations, it may be desirable to place the cells on the paper in a predetermined pseudo-random pattern but not a regular grid arrangement as shown in FIG. 10.

The cell dimensions are not limited to those listed above. One such shape is that the minimum cell size is equal to the pixel, as shown in FIG. 11. The cell wall heights can be very low as shown in FIG. 12a and 12b or can be high as is demonstrated in FIG. 12c and 12d and 13a and 13c. To further improve the image quality, especially in the low density areas of a photograph, the bottom of these large cells can be coated with a highly hydrophilic and low absorbing thin film, such as cross linked gel, so that even a single 1 pL droplet expands throughout the 84×84 μm² cell area.

An additional advantage of having the cell array on the receivers and depositing the various color inks in them simultaneously, that is long before a substantial absorption into the image receiving layer occurs, is that the various colorants will have time to mix thus producing truer color.

There are a number of ways to make the cells and a variety of materials that meet the requirements. In one method the cells are made on top of the currently commercial ink jet papers, such as shown in FIGS. 1 or 2. The process starts with inkjet paper onto which is coated, by wet roll or curtain coating, a thin layer of sol-gel (which may be an aqueous solution of a silica chemical species or metal alkoxides and water in an alcoholic solvent) and then drying of this coat at near room temperature. The resulting dried film, called xerogel, is transparent and has the important property that it is not etched by oxygen plasma. Then a thick layer of a plastic film is coated, which eventually will form the cell walls. The properties of this film are that it forms a scratch resistant film after it cools, that it is impenetrable to water and oils and that it can be doped with UV absorbing dyes. Suitable materials include, for example, polyethylene adipate, polycaprolacine, epoxy modified polyethylene, and maleic anhydride modified polyethylene. Another thin layer of sol-gel is then coated on top of the plastic layer followed by a coating of photoresist. This photoresist film is then exposed through a mask and developed forming the desired cell pattern. For the purpose of high productivity and low cost, and to obviate problems arising from the internal stresses of the various films, it is best to utilize a web-based process for all these steps. Now, with the photoresist as the mask, the top xerogel layer is etched selectively in a plasma environment containing active fluoride ions that react with the Silicon in the xerogel matrix forming volatile SiF₄ molecules, thus removing the layer. The paper is subjected next to another plasma environment this one containing oxygen ions. This process removes the plastic film in the desired cell areas and the remaining photoresist but does not affect the top xerogel layer, thus protecting the top of the cell walls. Then the fluoride ion plasma etch process is repeated to remove the xerogel film on the top of the cell walls as well as the xerogel film at the base of the cells.

In the embodiment as described in FIG. 3 where the image receiving layers are only in the base of the cells, then the cells are built on top of the polyethylene film that coats the paper base, in exactly the same way as described above. Then at the end of that process, the image receiving layers are coated over the cells and are allowed to settle into the bottom of the cells.

Other methods of fabricating the cells are by embossing, as taught, for example, in U.S. Pat. No. 4,307,165; stamping, as discussed, for example, in the article entitled “Flexible Methods for Microfluidics” by George M. Whitesides and Abraham D. Stroock in the June 2001 Issue of Physics Today or as taught is U.S. Pat. No. 6,197,482.

With the foregoing embodiments, it is thus possible not only to satisfy the ink handling requirements, but also to meet the criteria for photographic quality prints with as few as four inks per print head for low cost and fast printing times.

The entire contents of the patents and other publications referred to in this specification are incorporated herein by reference.

PARTS LIST

10 Top swellable polymer containing mordant

20 Bottom swellable polymer containing mordant

30 Polyethylene or other hydrophobic film

40 Paper base or other hydrophilic support

50 Polyethylene or other hydrophobic film

60 Backside anti-curl layer

70 Cells

80 Ink droplet

82 First color ink

84 Second color ink

90 Cell walls

100 Over-layer

500 Image receiving layer

510 Second image receiving layer

520 Third image receiving layer

530 Polyethylene layer

540 Paper base

550 Polyethylene layer

600 Hydrophilic ink absorbing area

610 Cell walls

What is claimed is:

1. A media for receiving jetted ink containing imaging colorant comprising a support bearing a predetermined array of three dimensional cells composed of cell walls and a base, the cross-section of the cells parallel to the support being of a size sufficiently small so as to improve the color image quality attainable compared to cells of larger size.

2. The media of claim 1 in which there are at least 16 cells per 7056 μm² of media imaging surface area.

3. The media of claim 1 in which there are at least 25 cells per 7056 μm² of media imaging surface area.

4. The media of claim 1 wherein the predetermined array is a regular pattern.

5. The media of claim 1 wherein the predetermined array is not a regular pattern.

6. The media of claim 1 wherein the plan cross section of the cells parallel to the support is circular.

7. The media of claim 1 wherein the plan cross section of the cells parallel to the support is one leaving substantially no space between cells.

8. The media of claim 7 wherein the plan cross section of the cells parallel to the support is rectangular, square, hexagonal, or rhomboidal.

9. The media of claim 1 wherein the liquid volume of the cells is predominantly less than 20 pL.

10. The media of claim 9 wherein the liquid volume of the cells is predominantly less than 10 pL.

11. The media of claim 1 wherein the cells have a volume of not more than 4 pL.

12. The media of claim 1 wherein the cells have a wall height of not more than 10 μm.

13. The media of claim 1 wherein the cells have a wall height of not more than 1 μm.

14. The media of claim 1 in which the cells are bonded to the hydrophilic base.

15. The media of claim 1 in which the cells are bonded to a hydrophobic layer.

16. The media of claim 15 wherein the base of the cell is hydrophilic.

17. The media of claim 1 in which the cell walls are fusible.

18. The media of claim 17 in which the cell walls are fusible at a temperature below 100° C.

19. The media of claim 1 wherein the walls contain a UV absorber.

20. The media of claim 1 wherein the walls contain a colorant stabilizer.

21. A process for forming an image comprising imagewise jetting an imaging colorant onto the media of claim 1.

22. A process for forming an image comprising imagewise jetting an imaging colorant onto the media of claim 3.

22. A process for forming an image comprising imagewise jetting an imaging colorant onto the media of claim 10.

23. A process for forming an image comprising imagewise jetting an imaging colorant onto the media of claim 13.

24. A process for forming an image comprising imagewise jetting an imaging colorant onto the media of claim 14.
